(19) United States
(12) Patent Application Publication
(10) Pub. No.: US 2004/0210450 A1
(43) Pub. Date: Oct. 21, 2004

(54) System architecture for self-provisoning services and method of use

(76) Inventors: Michael Atencio, St. George, UT (US); Brian H. Beebe, Orem, UT (US)

Correspondence Address: Brent T. Winder, Jones Waldo Holbrook & McDonough, 170 South Main Street, Suite 1500, Salt Lake City, UT, 84101, US

(21) Appl. No.: 10/713,528

(22) Filed: Nov. 13, 2003

Related U.S. Application Data
(60) Provisional application No. 60/427,672, filed on Nov. 19, 2002.
(60) Provisional application No. 60/435,947, filed on Dec. 20, 2002.

(51) Int. Cl. G06F 17/60

(52) U.S. Cl. 705/1

(57) ABSTRACT

A system architecture and method for allowing a subscriber to self-provision a service, or a plurality of services. Components for controlling service management, account management and device management for facilitating the self-provisioning of services by a subscriber, or a plurality of subscribers of communications and/or media services is described; wherein, a service provider is organized to provide a plurality of services to a subscriber device, or plurality of subscriber devices; an infrastructure is designed and configured to transport services from the service provider to the subscriber device(s); and a system control enables the subscriber device(s) to receive the services over the infrastructure from the service provider.

### PRIORITY INFORMATION

This application is based on, and claims priority to, the provisional application filed Nov. 19, 2002 entitled “An Accounting and Management System for Self-Provisioning Digital Services”, serial No. 60/427,672, as applied for by inventor Brian H. Beebe, and the provisional application filed Dec. 20, 2002 entitled “An Accounting and Management System for Self-Provisioning Digital Services”, serial No. 60/435,947, as applied for by inventors Brian H. Beebe and Michael Atencio.

### TECHNICAL FIELD

This invention generally relates to a system and method for allowing a subscriber to self-provision a service, or a plurality of services. Specifically, there is a system architecture and method described that includes components for controlling service management, account management and device management for facilitating the self-provisioning of services by a subscriber, or a plurality of subscribers of communications and/or media services.

### BACKGROUND

The communications industry has existed for a number of years. Among the first service providers to enter the market were the Bell companies, which primarily provided basic telephone services. Later, the wireless industry was born and the introduction of cellular phones changed the way the world viewed personal communications. Similarly, within the media industries, such as cable, content based service providers witnessed significant technological advancements and refinements, such as digital capabilities, which resulted in an enhanced ability to provide more options to customers. In addition, Internet service providers offered access to the Internet and, as a result, many types of data services through the web.

As a result, the communications and media industries have become increasingly concerned with the ability of service providers to offer a plurality of services to customers while avoiding the endemic inefficiencies and/or problems associated with the individual services provided. There is currently a general shift within these industries from primarily network and product-centric business models, to more customer friendly plans. Entities in both markets are researching ways to synchronize and coordinate customer relationships across a wide variety of services. Thus, in an effort to achieve more market share and to generate additional revenue streams, various service providers from the communications and media industries have started to consolidate their services to offer bundled, or packaged services to their subscribers.

Although voice, video, and other digital or analog services are starting to be provided by single organizations, these services are still managed and operated by distinct and relatively independent systems within the parent organization. For example, the typical step of processing a new order for services takes many man-hours and is usually enabled through different systems for each service.

Consequently, there appears to be a need to integrate all of these types of services into a unitary and cohesive umbrella service package, or a single integrated offering. Specifically, a system is needed for service providers to help subscribers self-provision and manage any type of communications and/or media service within a common infrastructure. In common practice, when a customer subscribes to a service, thereby becoming a subscriber, he/she is subscribing to the actual service, and not the equipment. There is a need for a method of provisioning services wherein: a plurality of services may be available to the subscriber; the subscriber can maintain ultimate control over the kinds of services provisioned; the subscriber can manage all services as offered by a plurality of independent service providers through a single package, or integrated offering; the subscriber may be billed by a single provider; and/or the subscriber can change his/her selection of services, or subscriber status, at any time.

Therefore, and even more specifically, a need exists for a system that provides a single interface for the subscriber to add, modify, and/or delete all types of services at an appropriate level of individual service descriptiveness and detail. This interface should allow the subscriber to select for the provisioning of all of the service parameters without requiring customer service personnel, or other inefficient intermediate steps and/or support, to add or otherwise amend their designated services. This system should provision the software and hardware required for all types of services including, but not limited to: public utility services, residential services, commercial services, and/or military or government services.

Any and all of the required configuration changes and dependent systems of the actual equipment and hardware comprising the service delivery and transport steps should be handled by the present method and system architecture. The configuration changes required may include a wide variety of parameter changes to the equipment, such as a phone or computer, to facilitate the provisioning of a service. Examples of such changes may include, but are not limited to, adding menu items, adding available channels, or other changes in bandwidth. Similarly, the systems depending from such equipment will also need to be modified and customized to reflect the change in service(s). In the backend, or framework of supporting database solutions, the system should have the capability to integrate all of the supporting equipment and hardware, yet have a common/generic methodology of handling the provisioning of this equipment and hardware. It may also be advantageous for this type of system to be modular and extensible in order to support all types of equipment and hardware.

### SUMMARY OF THE ILLUSTRATED EMBODIMENT(S)

The present invention generally relates to a system that manages the provisioning of services to subscribers. Specifically, there is a method described that includes a system architecture for controlling service management, account management and device management for the provisioning of services to a subscriber, or a plurality of subscribers of communications and/or media services.

The system architecture for facilitating the self-provisioning of services by a subscriber, may be designed to generally include a service provider, a subscriber device, an infrastructure, and a system control. The service provider may be organized to provide a plurality of services to the subscriber device, or plurality of subscriber devices. The infrastructure may be configured to transport services from the service provider to the subscriber device(s). Finally, the system control enables the subscriber device(s) to receive the services over the infrastructure from the service provider.

More particularly, the system control includes a device management system, that is designed to manage and regulate the distribution, activation, and functioning of the subscriber device(s), as incorporated into the infrastructure. There is also described a service management system, that allows the subscriber, via a graphical user interface, to manage functions that modify the services offered by individual service providers which are entered into said system. There may also be an account management system that allows a subscriber to manage and review account data regarding the subscriber's individual account(s).

Yet another feature of the present embodiment may be to provide a system that is designed to manage all of the processes and information, such as but not limited to account information, subscription information, available service offerings, or the form of delivery, for providing electronic services over a network. A preferred element of the present invention may be the ability of a service provider to easily provision new services to a plurality of subscribers in addition to the ability for the subscriber to manage his/her own service offerings. Examples of this unique capability may include the ability of a subscriber to manage services typically offered by independent service providers, such as, but not limited to, Voice over Internet Protocol (hereinafter referred to as “VOIP”) services, digital video or cable services Internet access services, and wireless services. The subscriber may then choose which services, or sub-services, in which he/she wished to participate, such as Internet access and digital video, provided for example only.

### BRIEF DESCRIPTION OF THE DRAWINGS

FIG. 1 is a network block diagram of the present invention connected to a typical service delivery network, such as but not limited to a cable provider's infrastructure and network, an internet service provider's infrastructure and network, and a wireless provider's infrastructure and network, showing the components involved.

FIG. 2 is a network block diagram of the present invention connected to a typical service delivery network, such as noted above.

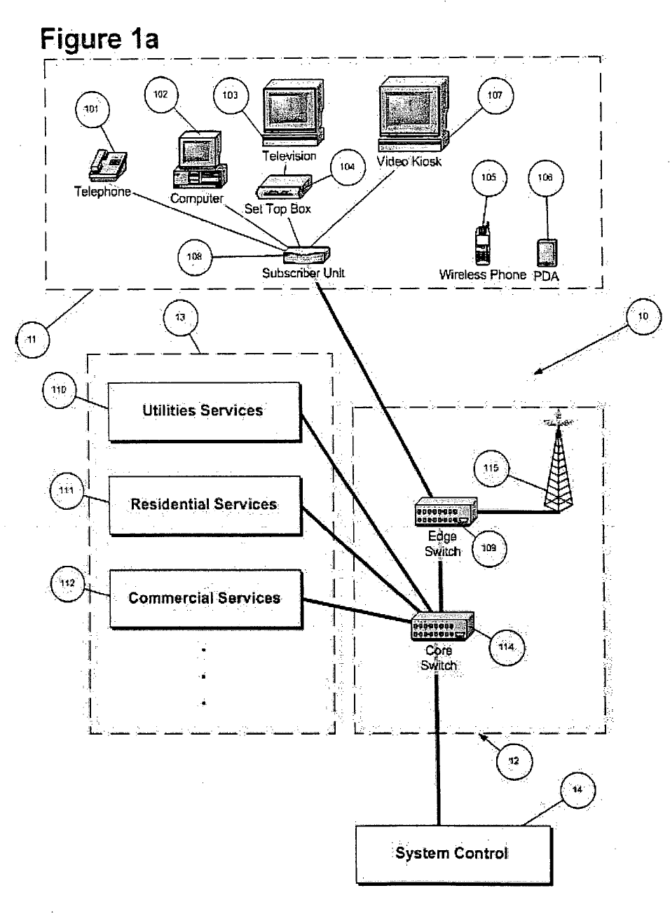

FIG. 3 is a block diagram of the Accounting and Management System for Self-provisioning Digital Services architecture of the present invention

FIG. 4 is a block diagram of the processes and storage entities involved in the Service Management function of the present invention.

FIG. 5 is a block diagram of the processes and storage entities involved in the Device Management of the present invention.

FIG. 6 is a block diagram of the processes and storage entities involved in the Account Management of the present invention.

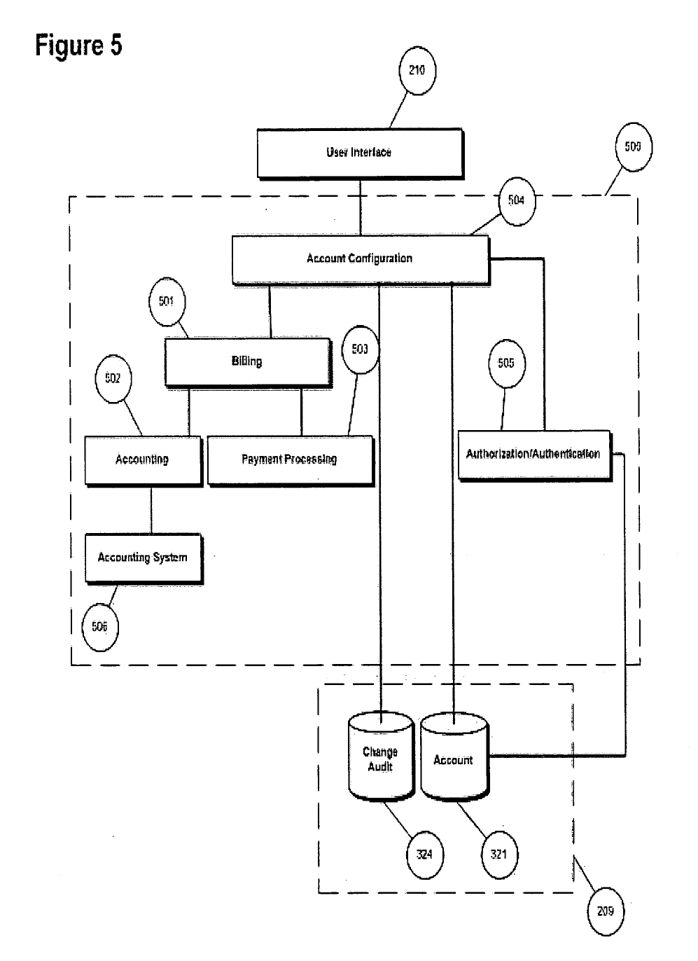

### DETAILED DESCRIPTION OF THE ILLUSTRATED EMBODIMENT(S)

The following is a specific description of a representative application of the presently described invention, wherein the operation and provisioning of a specific service, in this case a digital video service, is discussed. This is offered merely as a single example of the myriad of services that may be provisioned and delivered to a subscriber, or self-provisioned, using the present system architecture 10. This example is not meant to limit the application of the invention, but is offered merely to illustrate the specific operation as it pertains to the specific example. Persons possessing knowledge of one skilled in the art will likely understand, after review of the following example, how to apply the present invention to many other types of services.

A certain company may be in the business of providing network services over a wireless network to customers within a specific metropolitan area. One of the many services that they offer may be a digital video service, whereby a subscriber can select a movie to watch from a database of movies.

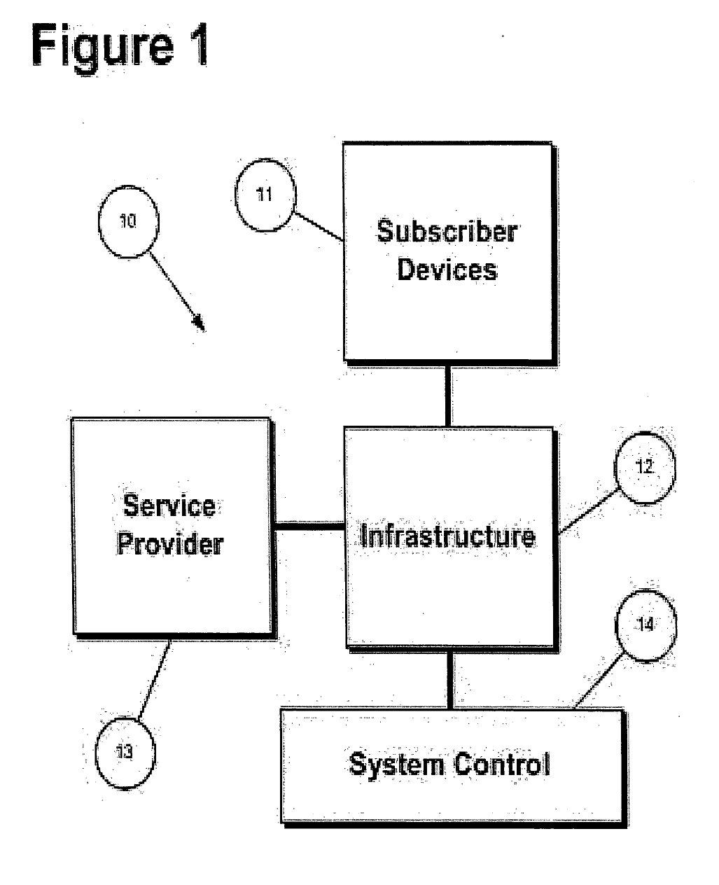

In this example, now referring to FIG. 1, the subject company is a service provider 13 and owner of its infrastructure 12 for facilitating the management, delivery, and transport of services to a subscriber or plurality of subscribers, such as a network in the present example. The service provider 13 uses a system control 14 to provision the services it provides via a myriad of potential subscriber devices 11, such as wireless receivers. In the present example, it is suggested that the main component involved in the delivery of the service by the service provider 13 begins with a video server. This server may contain an MPEG encoded movie with controlling software to be able to tell the video server when to start streaming the ordered video and to which address (i.e. the set top box, as discussed below).

Referring also to FIG. 1a, the infrastructure 12 then carries the video stream to the subscriber's set top box 104. The infrastructure 12 may be logically divided into as series of virtual local area networks (hereinafter referred to as “VLAN”) to protect different types of services, such as voice and video, from each other for security purposes or to enhance performance. In the home of the subscriber, a wireless network may terminate with an Ethernet bridge that is, in turn, connected to a subscriber unit 108. The subscriber unit 108 may include an Ethernet switch with many available ports, making it possible to connect with a plurality of subscriber devices 11. To one of these ports, the set top box 104 may be connected. The subscriber unit port may be configured to connect to the video service VLAN. The set top box 104 converts an MPEG video stream to a standard signal that would be compatible with a normal television set 103. In this example, the set top box 104 might display an interactive program guide, as typically using a modified HTTP browser.

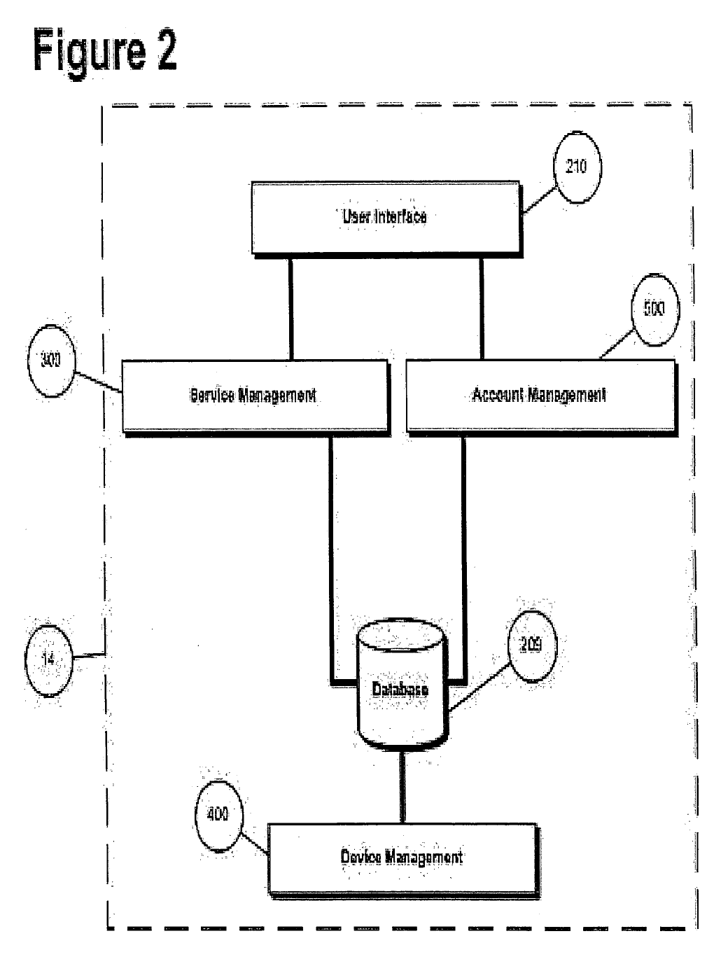

Referring to FIG. 3, this interactive program guide acts as a user interface 210 to systems for service management 300 and account management 500. With a TV remote control device, the subscriber can configure the service options that they want, which thereby initiates the delivery of the video to be displayed on the subscriber's television set 103. Still prior to delivery, however, the system needs to be provisioned. Thus, the following may be a general description of an example of a method of provisioning the movie video service.

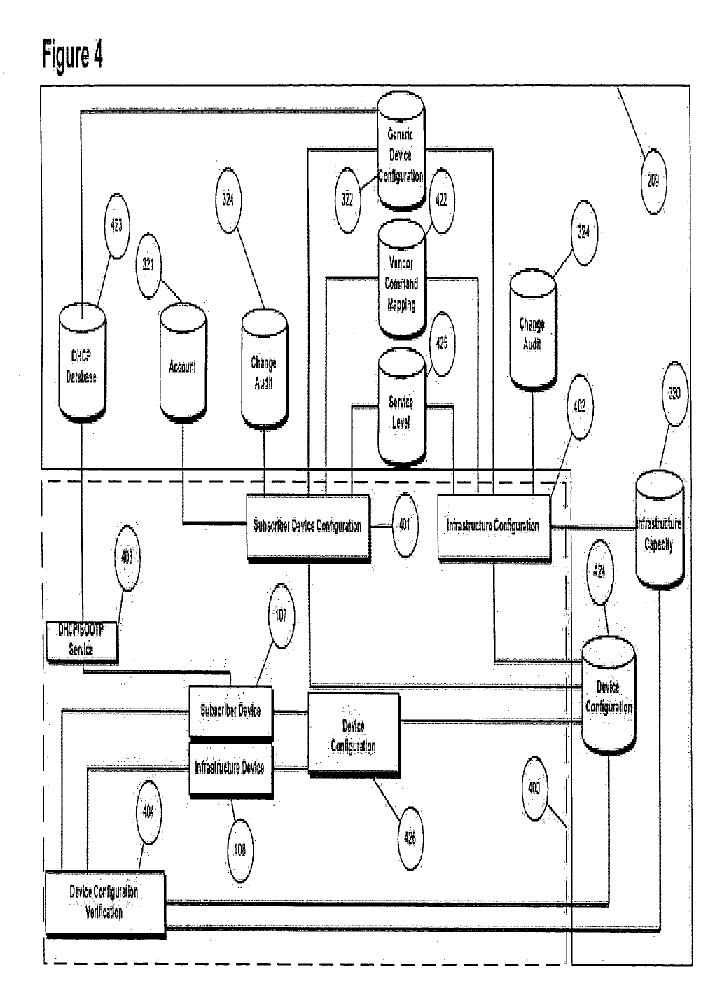

Initially, it may be assumed that the subscriber already has a subscriber unit 108 connected to a wireless infrastructure and may be currently subscribed to receive Internet access. For the first step in provisioning a new service, the subscriber, using a computer 102, referring to FIG. 5, with an HTTP browser, may connect to the user interface 210 of the system control 14. The subscriber may then log into their existing personal account 321 using a user id and authenticating information, which may be a password. The account configuration 504 would then authenticate 505 this user against the previously entered subscriber information contained in the account database 321. The subscriber might then be presented with a menu of account and service options that correspond to his/her user authorization 505. Assuming that this user id has authorization to add or remove a service, the subscriber would then be allowed to choose to add the digital video service.

The original selection of the digital video service option may only require payment for that service, if the appropriate hardware is already owned. However, if the hardware needs to be purchased, a subscriber may want to purchase the hardware, such as a set top box 104, at the time of first ordering the movie service.

Referring again to FIG. 5, once the particular movie service is selected, a method of payment for that service may be identified. In setting up the new subscriber account 321 within the system architecture 10, the user would have to organize such an account 321 to handle financial transactions through a specific payment method. For purposes of illustration, the subscriber opts to use a credit card to handle all financial transactions related to their account. Since the account configuration process 504 allows the original subscriber to limit certain amounts of financial transactions, this user, which may or may not be the original subscriber, may need to provide authorization for payment for provisioning the digital video service and set top box 104. Assuming that authorization is completed, the account configuration process 504 would record the charges for the digital video service using a billing process or solution 501. The billing process 501 would then direct the accounting process 502 to record the transaction in the accounting system 506. The authorized payment may then be handled by the payment process 503, which would initiate the credit card payment transaction.

Upon completion of the account management process 500, the service management process 300 may provision the service for the subscriber. First, now referring to FIG. 3, the new digital video service may be added to the subscriber's database 321. Then a service configuration process 305 checks a capacity validation process 301 to make sure that the infrastructure 12 can handle this new digital video stream. The service configuration process 305 will then check a service info database 323 to determine which changes need to be made to the subscriber device 11, the infrastructure 12, and the service provider 13. Since this new service requires a new set top box 104, a service request process 304 will send a service ticket to an order fulfillment department, for example, that will send the set top box 104 to the subscriber. Before the set top box 104 may be sent, however, its media access control (hereinafter referred to as “MAC”) address, which has a hardware level address that may be unique to all network equipment, may be updated in the standard device configuration database 322, and may be assigned to that particular subscriber.

Next, a generic device configuration process 303 may update the generic device configuration database 322 with a modification to the subscriber's subscriber unit 108, which will enable port 3, for example, of the subscriber unit 108, and connect it to the video servi internet protocol ce VLAN. The generic device configuration process 303 will then assign the next internet protocol (“IP”) address, according to the capacity validation process 301, to the configuration of the set top box 104.

Now that the service management process 300 has configured the service, a device management process 400 may be employed to configure the specific subscriber devices 1, particularly the subscriber unit 108 and set top box 104. Initially, a subscriber device configuration process 401 (hereinafter referred to as “SDC”) detects that the subscriber info database 321 has been updated with a new set top box 104 for the specific subscriber. The SDC process 401 will retrieve the generic configuration from the standard device configuration database 322 and detect that it may be a set top box device, which may be described as Type C from Vendor X, for example.

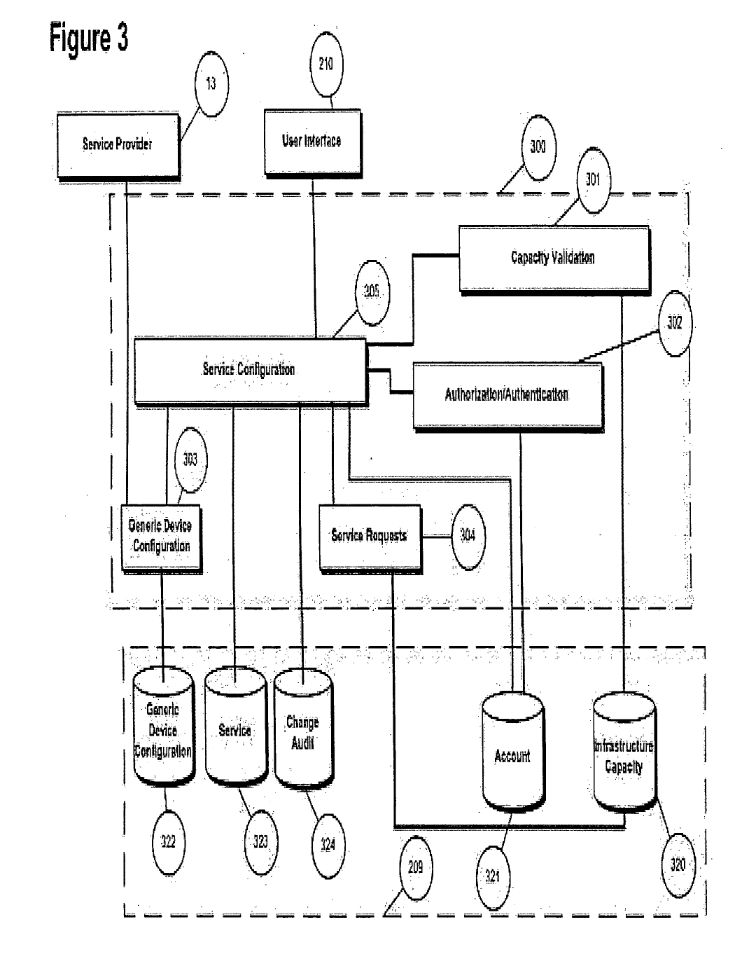

Referring to FIG. 4, the SDC process 401 will then look up this type of set top box in a vendor command mapping database 422 to find out how to configure the this specific type of device. The generic device configuration database 322 will then be synchronized with a Dynamic Host Configuration Protocol (“DHCP”) database 423, which is configured to contain currently assigned EP addresses, to include the following, and not in limitation: the MAC address, the new IP address of the set top box, and the name of the configuration file in the device configuration database 424. The SDC process 401 will then generate a vendor specific configuration file and store it in the device configuration database 424 for later retrieval.

After the SDC process 401 has configured the set top box 104, it will begin configuration of the subscriber unit 108 by first reading the changes made to the generic device configuration 322 and then determining that the subscriber unit 108 may be of Type E from vendor Q, for example. Next, vendor specific device commands for the subscriber unit Type E are retrieved from the vendor command mapping database 422. An infrastructure rules database 425, which contains constraints developed by operations personnel, is then checked, since other services depend on this specific subscriber unit. For example, it may be determined that this specific subscriber device 11 would need to be rebooted to make this change. In that case, a dialog would be initiated with the subscriber using the user interface 210 to gain permission for an immediate reboot.

Upon being granted permission, the SDC process 401 will create the specific configuration file for this device. A device configuration process 426 will then start up the specific configuration process that will read the specific configuration file for the subscriber unit 108, which will then begin an interactive configuration of the device. At the end of the configuration, the device may be rebooted and the configuration process may be finished.

Once the set top box 104 is received by the subscriber and is connected to the subscriber unit 108, the set top box 104 will initiate a self-configuration process by sending out a DHCP request to a DHCP service 403. The DHCP service 403, which may be any service used to provide dynamic addressing to a subscriber device 11, will respond by sending a reply back to the set top box 104 with an EP address and a location of the configuration file. The set top box 104 assigns itself this IP address and then uses the device specific protocol to upload the configuration file from the vendor specific configuration process 426.

Because the basic provisioning of digital video services has been accomplished, each time a subscriber orders another movie, the system control 14 undertakes a similar process to that of first provisioning the original set up. Specifically, no changes need to be made to the specific subscriber devices 11 or to the infrastructure 12 since these devices remain unchanged, as originally provisioned. It should be noted that the ordering of a movie would go through the exact same steps as the original provisioning, except that the device management process 400 does not need to be executed. Specifically, the system control 14 will provision the specific movie by providing the service provider with the data needed to know what movie was ordered and where to deliver the streaming video data. For each movie ordered, the accounting process 502 will also update the account balance and the payment processing 503 will make the necessary payment transactions that were previously specified for this subscriber account. In this example, the subscriber's credit card account will be billed for the ordered movie.

For future service choices by the subscriber, the system 10 may then present to the subscriber the available service offerings, the relevant parameters involved, and the cost of each of the service offerings. The subscriber would be able to create an account and complete the financial transactions necessary to activate the account. This would then update the subscriber info database 321 with the subscriber's new account information. In addition, this would automatically initiate a series of dependency processes, such as but not limited to the issuing of an order to provide equipment, to update the networking devices, or to update the account database that would issue service requests for any and all physical provisioning needs. The device configuration database 424 may be updated to support the addition of new equipment. The equipment may then be shipped out to the subscriber's location; whereupon, the subscriber may then activate the same. The equipment may be configured with previously defined information, such that the subscriber would be able to add and/or remove additional services.

The following is a general description of the present invention as not specifically related to the example provided, but offered as further description of the elements presented in the drawings. The user interface 210 provides a specific interface to the service management 300 and account management 500 processes. The user interface 210 translates requests from different subscriber access methods. Although it is envisioned that other access methods will be supported as those methods become widely developed and used, a few examples are listed below, for illustrative purposes only:

1. Personal Digital Assistant (“PDA”) (with network access usually having a “mini” browser that can support either wireless markup language (hereinafter referred to as “WML”) or hyper text markup language (“HTML”).

2. Computer with network access, usually having an HTML web browser.

3. Wireless phone with network access, usually having a WML browser that can access the user interface using Wireless Access Protocol (hereinafter referred to as “WAP”) or can use Integrated Voice Response (hereinafter referred to as “IVR”).

4. Phone with network access, usually utilizing an IVR interface.

This user interface 210 process may be the same process that a customer service representative uses to verify information in the system and to check the status on service delivery. The user interface 210 process uses user privilege levels to determine what subscribers and customer service representatives can see and do. Depending on the specific operation to be performed, the request will be processed by either the service management 300 or account management 500 processes.

The service management 300 process receives the changes from the subscriber for the new or changed service. The process updates the database with the changes to the service and makes requests for changes to the devices. If changes to a service require operations personnel intervention, the service management 300 process will send notification to operations personnel.

The device management 400 process receives requests for device changes from the service management 300 process. The device management 400 process will write the generic configuration changes to the database. It will then create vendor specific configuration commands for the subscriber devices 11, the infrastructure devices 12 and the service provider 13.

The user interface 210 presents data to the user/subscriber. It performs this task by determining the correct protocol and formatting to present the relevant information to the user/subscriber. This data may then be input into the account management 500 system. If the subscriber does not have a subscriber account organized, they must set it up before they can perform any other functions. In order for an account to be organized, a payment mechanism must be created through the billing 501 process. The billing 501 process facilitates setting up the payment processing 503. Actual payment processing 503 may be handled by a separate process so that it can be provided by third party billing systems and/or providers. Once a billing account is created, a subscriber account can be organized. All service changes involving billing transactions are entered into the Accounting 502 system. Similarly, the subscriber-information may be entered and recorded into the account database 321. The account database 321 contains all of the information concerning a subscriber. For each subscriber, one or more users exist; wherein, each user has associated privileges. These privileges determine the number and types of changes the user may initiate within the subscriber account. A user enters the system by providing a user id and authenticating credentials through the authorization/authentication 505 process. All actions performed by the account configuration 504 process are logged to the change audit 324 function.

The account management 500 process may be designed to handle the following operations:

1. Add users

2. Change user permissions

3. Setup authenticating information

4. Setup billing account and payment options

5. Review account history

6. Authorize payments

Once the user has been authenticated, access into the service management 300 system may be permitted.

Further, the user interface 210 provides the presentation of data to the subscriber. It determines the correct protocol and formatting to present to the user/subscriber. This data may then be input into the service configuration 305 process, which controls the provisioning of the selected service. An authenticated user, verified by the authorization system 302, can make changes to service choices and other service parameters. When a service is added and/or changed, a capacity validation 301 check may be performed in order to determine whether the infrastructure and the service provider can support the requested service change. If the infrastructure or the service provider need to have a license or physical change, if a subscriber device must be sent to the subscriber, or if any other change that requires the action of personnel is requested, the request status is set to “pending” and a service request 304 may be generated. In addition, the service request 304 may be sent to the operations staff of the system control 14 to execute that action. Next, authorization and confirmation data may be requested from the subscriber in order to finalize the subscriber's request for the service change. Typical examples of a subscriber's requests might include without limitation:

1. Send device to subscriber

2. Add additional capacity to infrastructure

3. Upgrade facility

4. Bring wiring facilities to subscriber

5. Upgrade software licensing

6. Add additional capacity to service provider

Once a service request 304 has been completed and changes have been made to the infrastructure, the infrastructure capacity 320 may be updated with the changes.

For each change to the service that is requested, authorization 302 may be checked to verify whether the particular user has privileges to make the requested changes. Each change may be recorded in the change audit 324 system.

For each service change, a corresponding device and/or service provider change may be necessary. The service database 323 contains all the service parameters and necessary device parameters needed for each service. These generic device parameters are then recorded to the generic device configuration database 322 by the generic device configuration 303 process. The generic device configuration database 322 may be a unified configuration independent of vendor syntax. The device class will have a generic description of its configuration. A device class would exist, for example, for a telephone 201, a set top box 204 or a subscriber unit 208. In addition to changes made to the devices, configuration changes needed for the service providing software are sent to the software provider.

The Service Management 300 process may handle the following operations, named without limitation:

1. Adds services

2. Changes service parameters

3. Schedules services

4. Changes service levels

5. Deletes services

6. Views current subscribed service

7. Adds device

8. Organizes initial Configuration

9. Reviews change history

The device management 400 process performs the actual device configuration for the two types of devices in the network, namely the subscriber device 107 and the infrastructure device 108. For the subscriber device 107, the SDC 401 reads the generic configuration information from generic device configuration database 322 and then reads subscriber specific parameters from account database 321. It may then translate the configuration to a specific device configuration and store it in the device configuration database 424, according to the vendor of the device. The translation mappings from the generic device configuration database 322 and the device configuration database 424 are contained in the vendor command mapping 422 system. The SDC 401 will also determine how and when the configuration change will take place using the infrastructure rules 425. These rules may be created by operation staff to prevent any unscheduled downtime. The device configuration 426 process uses a file located in the device configuration database 424 to configure the device. The device configuration 426 processes described in FIG. 4 illustrates examples of the processes that are needed to configure the current equipment. It is envisioned that other configuration methods will be supported as those methods become more widely used. The device configuration verification 404 process periodically checks the actual configuration of the device with the device configuration 424 system. It performs this function with information found in the infrastructure capacity 320 to determine system configuration integrity. All changes made within the SDC 401 and/or the infrastructure configuration 402 may be recorded in the change audit 324 system.

A synchronization of data may be made between the IP address information located in the standard device configuration 322 and the DHCP Database 423. The DHCP/BOOTP service 403 provides a standards-based method of configuration IP address information on the Subscriber Device 107 by implementing the DHCP and Boot Protocol (“BOOTP”) standards as defined above.

The only difference between the SDC 401 and the infrastructure configuration 402 may be the type of device they are designed to configure. The subscriber device 107 is a device that may deliver service to one and only one subscriber. The corresponding subscriber and operations staff are the only persons that can make changes to this device. The infrastructure device may be any device that constitutes a main component of the infrastructure, and also services multiple subscribers. Examples of such devices include, but are not limited to, the core switches 214, edge switches 209, and transmitters 207.

It should also be noted that the provisioning of the system 10 might be specifically accomplished through service management 300 and device management 400.

### DESCRIPTION OF TERMINOLOGY

A subscriber may be a customer or user of the services offered by a service provider.

The general definition for the concept of provisioning may be the act of performing those tasks needed to install, activate and configure any devices and/or software (including systems) necessary to provide a specific service from a service provider to a subscriber. This definition is intended to reflect the common definition as used in the communications and media industries, such as in the telephone and Internet services industries, for example. It may include service design as well as the management of resources assigned to those services. More specifically, it may include but is not limited to provisioning device features, validating service functions, configuring delivery mechanisms and managing configuration processes generally. It is noted that the word process may be considered to be interchangeable with the word system throughout the present disclosure.

Subscriber Device 11 represents a myriad of physical devices, such as, but not limited to, wireless receivers, used to deliver electronic services to a subscriber.

Infrastructure 12 represents a myriad of physical devices, such as, but not limited to, firewall servers, dishes, gateways, and encoders, that are used to manage, deliver and transport service to a plurality of subscribers.

Service provider 13 is an entity, or group of entities, and/or a device, or group of devices, that offers and provides services to the subscribers via subscriber devices 11. This includes the software, hardware and/or content needed to enable or encode the service(s) offered by the service provider(s) to be delivered to the subscriber devices, and to be provisioned by the system control 14 or subscriber him/herself. Examples of service providers may include public utility service providers, private industry providers, or government and military service providers.

Services are communications services, such as digital video, offered and provided by a service provider, or service providers, to a subscriber.

Telephone 101 may include any device capable of calling a phone number and transmitting voice to the opposite end.

Computer 102 may include any computing device that has a HTML browser and may be connected to a network.

Television 103 may include any device used to display NTSC and/or PAL signals.

Set Top Box 104 may include any device, which takes a digital signal from the network and converts it to NTSC or PAL signaling to be viewed by a television 103.

Wireless Phone 105 may be any portable phone with wireless data capabilities such as WAP.

PDA 106 may be a portable device that has the capability for wireless data connectivity to a network and has a specialized web browser suited to its small form factor.

Video Kiosk 107 may include any stand alone device designed to convert a digital video stream to be display via a built in display.

Subscriber Unit 108 may include any device used to facilitate connectivity to the service providing network infrastructure.

Edge Switch 109 may be a switch which has many connectivity ports and supports multiple subscribers. This switch may be geographically close to a subscriber. Potential devices which fall under the present definition may include: internet packet based routers and switches, Ethernet switches, asynchronous transfer mode (hereinafter referred to as “ATM”) switches, multi-protocol label switching (hereinafter referred to as “MPLS”) switches or any legacy type systems including private branch exchange (hereinafter referred to as “PBX”), class 5 switches, and/or cable systems.

Utilities Services 110 represents the systems and equipment needed to provide information about utility usage such as for, but not limited to, the utilities of gas, electricity, and water.

Residential Services 111 represents the systems and equipment needed to provide services to residential customers such as for, but not limited to, phone services, video services, powerline media services, and Internet access services.

Commercial Services 112 represents the systems and equipment needed to provide services to commercial customers such as for, but not limited to, video kiosk services, advertising services, surveillance services, and IT services.

Core Switch 114 may include any switch, which provides centralized data transportation services to the infrastructure. This could include: IP—based routers and switches, Ethernet switches, ATM switches, MPLS switches or any legacy type systems including PBX, class 5 switches, and/or cable systems.

Transmitter/antenna 115 may include any device used for wireless communication, such as but not limited to wireless stations, such as a General Packet Radio Service, or GPRS, cell tower.

Database 209 is the general term used to describe any organized storage of information created or used by the present invention.

User Interface 210 may be any process that formats data from the system and presents it to subscribers and/or customer service personnel in a method that may be easy to comprehend and use, and may be interpreted by a particular subscriber access method. Examples of subscriber access methods include access to communications media services through the use of PDAs, computers, phones, and/or wireless devices.

Service Management 300 represents the ability to choose from a group of functions of the present invention which permit the subscriber to make changes to the services being delivered.

Capacity Validation 301 may be any process or system with checks to see if the actual physical network has the capacity, such as ports availability, bandwidth availability, number and type of switches, and number and type of subscriber units 11, to support a requested service change.

Authorization/Authentication 302 may be any process, which checks a user's credentials against a database of authorized users for correct credentials and privilege levels.

Generic Device Configuration 303 takes a service change request and translates it into a device parameter change. Generic refers to the fact that at this stage the language used to describe that parameter change may be the same for a device class, such as a Set Top Box 104 or a Telephone 103, and is not specific to the vendor specific commands needed to make the actual changes.

Service Requests 304 are those requests, which cannot be handled by the system and must involve a technician such as laying cable, or repairing hardware damage or malfunctions.

Service Configuration 305 may be any process which coordinates the changes being requested by the subscriber with all of the processes needed to complete the service, and needed to make it possible to deliver the service to the subscriber.

Infrastructure Capacity 320 contains all of the information that describes the availability of switches, servers, cables, and related hardware in the infrastructure.

Account Database 321 contains all of the information describing the subscriber and the service parameters pertaining to that subscriber.

Generic Device Configuration Database 322 contains all of the general parameters describing the current configuration of the subscriber devices 11 and infrastructure devices 12.

Service Database 323 contains all of the information describing the types of services available, and the parameters associated with, the services offered.

Change Audit 324 contains all of the history of changes made to the system.

SDC 401 gathers information from the standard device configuration and uses the data from the Vendor Command Mapping, as described below, to create a vendor specific configuration file and/or script to be used to configure a subscriber device 11.

Device Management 400 represents the ability of a subscriber to choose from a group of functions of the present invention which translate subscriber service choices into configuration commands that are used to make changes to the hardware and software systems providing services.

Infrastructure Configuration 402 gathers information from the standard device configuration and uses the data from the Vendor Command Mapping, as described below, to create a vendor specific configuration file and/or script to be used to make actual changes to infrastructure devices 12.

DHCP/BOOTP Service 403 may be any service used to provide dynamic addressing to a subscriber device. DHCP and BOOTP are currently the two most common methods of assigning an IP address to a device.

Device Configuration Verification 404 may be any process which compares the configuration stored in device specific configuration 404 with the actual configuration on the subscriber devices 11 and infrastructure devices 12 to determine if there have been any manual changes made that have not been accounted for.

Vendor Command Mapping 422 may be any table or solution used to translate between generic configuration parameters and vendor specific configuration commands.

DHCP Database 423 contains all of information regarding the currently assigned IP addresses and those that remain available.

Device Configuration Database 424 may be any location where the output of vendor specific configuration files may be stored, and that are ready to be used by vendor specific configuration processes.

Service Level Database 425 contains constraints developed by operations personnel that affect when and how device changes can be made.

Device Configuration 426 represents the configuration transfer processes that are specific to each type of equipment, and required to support the same. New processes, tailored to the specific needs of new equipment or methods, would be added as new vendor methods are required.

Account Management 500 represents the ability of a subscriber to choose from a group of functions of the present invention which permits the subscriber to conduct financial transactions related to the services being provided, to manage the specific preferences pertaining to those services, and to review a history of the transactions conducted.

Billing 501 may be any process which manages the financial transactions involved with the subscriber's account(s).

Accounting 502 provides an interface to standard accounting systems.

Payment Processing 503 provides an interface to various payment processing systems.

Account Configuration 504 may be any process that configures the subscriber's account by adding users and checking service and payment histories.

Authorization/Authentication 505 may be any process, which checks a user's credentials against a database of authorized users for correct credentials and privilege levels.

Accounting System 506 may be any system dedicated to managing the accounting of an organization.

Payment Processing 507 represents those companies and/or systems that specialize in processing payments such as credit card payment processing.

Variations of the Illustrated Embodiment(s)

Although it has been illustrated to employ certain subscriber devices 11 as described herein, it may be well within the scope of the present invention or within the ability of one skilled in the art to envision or use other subscriber devices. Specifically, and by way of example, utility companies could use the system 10 to provision, manage and account for the subscribed utility services by way of the utility meter and a control device coupled thereto. Examples of utility services may include, but are not limited to, electric, water, gas, and sewage utilities.

Discussions regarding services 110-112 have specifically identified applications of the present invention to include general public utilities, general residential services and general commercial services; however, one skilled in the art will easily recognize that these designations may include many more sub-services not specifically named herein. For example, the following services may be included without limitation: voice services, which may include local voice calls, long distance voice calls, caller id, and Internet voice calls; and multimedia services, which may include video on demand, near video on demand, subscription video channels, local channels, personal video storage, online games, digital music, video kiosks. Video kiosks could be any type of public devices that display multimedia information from a single location. Examples may include, but are not limited to, movie ticket distribution, community event information, and advertising displays. Another example of a service 110-112 could include data services, which would include Internet access, e-mail, and instant messaging. Another example of a service 110-112 may be security services for commercial and/or residential subscribers such as remote alarming, surveillance, fire protection, etc.

In a further example of services 110-112 and service providers 13 as mentioned above, it is considered to be within the scope of the present invention to include an application for independent providers of applications and/or super service providers, also referred to herein as a Super Service Provider Solution (“SSPS”). Under a typical independent provider of applications or web-services model, a service provider can allow an independent service provider to offer services over the network independently, such as in element 13 of FIG. 1a. In this instance, the independent service provider would have control over the services that are offered, where under non-independent service provider arrangements, a service provider maintains complete control. Ultimately, for the present method, the service provider would still be able to activate the service, but service management would be performed by a separate entity. Billing may then occur under the same billing solution, or it can be billed separately through the independent service provider.

The SSP model allows a combination of services from various sources, such as different telecom or cable companies, and offers them as a single service with a single billing solution. For example, a customer goes to company X and Company X offers wireless, cable, and wireline telephone services from three separate entities, which have been bundled together. The present method can support this type of networking and provisioning. The end result for the customer is that he/she would then receive one bill per month instead of three.

Further, another example of services 110-112 and service providers 13 as mentioned above is the application of the present system and method to Network Centric Warfare (“NCW”) methods. NCW is a relatively new concept under consideration by the military that is designed to reduce battlefield mass, namely to replace large troops with smaller numbers augmented by sensors arrays that perform much of the work previously performed by battlefield personnel. As is common current practice, the sensor and the weapon are essentially one and the same; a soldier sits behind a 50-caliber machine gun, and if he/she spots a target of opportunity he/she fires at the target. Under NCW, the sensor may be a combination of sensing devices and remotely operated weapons that have the ability to correct trajectories in real-time. This is accomplished in part due to the existence of smart projectiles working closely with intelligent sensor arrays. These devices may be interconnected either wirelessly or via traditional wired infrastructures. The information is transmitted to a central location, perhaps thousands of miles from the theater of engagement, where it is analyzed, filtered and used to craft an appropriate and accurate response to the battlefield threat.

Under known NCW models, every soldier, weapon, vehicle, and projectile may be outfitted with sensor capability, making it possible to coordinate enormous amounts of incoming information and make informed decisions very rapidly and accurately. A negative aspect of this model is that all of that information, as well as the devices themselves, must be managed the same way a traditional telecommunications infrastructure, and the services provisioned over it, are managed. As a consequence, the present invention may be incorporated into military applications as easily as it can be used for civilian commercial customers.

More specifically, and as applied to the present method, NCW provides for the distribution of connected information by individual combat units of telecommunications, media, or video by displaying the position and status of combat units which may be viewed through a digital transmission or a similar packetized or analog transmission on the network. Relating the present example to FIG. 1, element 11 might consist of devices carried by tanks, troops, helicopters, or any type of medium for carrying a device capable of sending or receiving digital or analog signals on the network. Element 12, also of FIG. 1, might consist of satellite networks, fiber optic networks, or any other network that the military may use. Particularly in terms of security and limited access to the data transmitted, the self-provisioning of services may be set up to allow or restrict certain personnel. It is worth noting, however, that an application of the present invention to a NCW model would likely be successful without employing the billing solution 501 as described herein.

It may be noted that the infrastructure may also include many devices. For example, it may include a PBX, IP routers and switches, wireless, class 5 switches, and cable systems.

Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in the number of supporting devices, number and type of services provisioned, supporting systems, general form, function, and manner of operation, assembly, and use may be made, without departing from the principles and concepts of the invention as set forth in the claims.

1. A system architecture for facilitating a self-provisioning of services by a subscriber, the system architecture comprising:
a) a subscriber device (11), designed and configured to deliver the services to the subscriber;
b) a service provider (13), organized to offer the services to the subscriber device (11);
c) an infrastructure (12), designed and configured to transport the services from the service provider (13) to the subscriber device (11); and
d) a system control (14), designed and configured to enable the subscriber device (11) to receive the services over the infrastructure (12) from the service provider (13).

2. The system architecture of claim 1, wherein the system control (14) further comprises a device management system (400) that is configured to allow the subscriber to choose from a series of functions which may change the self-provisioning of services by reconfiguring the subscriber device (11) and the infrastructure (12).

3. The system architecture of claim 2, wherein the system control (14) further comprises:
a) a user interface (210), designed and configured to allow the subscriber to interface with the system control (14); and
b) a service management system (300), designed and configured to allow the subscriber, via the user interface (210), to manage functions that modify the capability of the self-provisioning of services.

4. The system architecture of claim 3, wherein the system control (14) further comprises an account management system (500), designed and configured to allow the subscriber, via the user interface (210), to access current information regarding the subscriber and the self-provisioning of services.

5. The system architecture of claim 4, wherein the system control (14) further comprises a database (209) that stores information related to the services, the subscriber, the subscriber device (11), the service provider (13), and the infrastructure (12).

6. The system architecture of claim 2, wherein the device management system (400) further comprises:
a) a generic device configuration database (322) that provides a vendor neutral description of a generic device configuration (303);
b) a vendor configuration mapping database (422) that provides translation of the generic device configuration (303) into vendor specific parameters; and
c) a service level database (425) that contains rules designed to regulate changes to the subscriber device (11) and the infrastructure (12) in order to minimize service disruptions.

7. The system architecture of claim 6, wherein the device management system (400) further comprises:
a) a specific device configuration database (424) that contains data regarding specific device configurations for the infrastructure (12) and the subscriber device (11); and
b) a SDC system (401) that is designed and configured to:
i) access the generic device configuration database (322), the vendor configuration mapping database (422), and the service level rules database (425);
ii) create data regarding the specific device configurations for the infrastructure (12) and the subscriber device (11); and
iii) store the specific device configuration data in the specific device configuration database (424).

8. The system architecture of claim 7, wherein the device management system (400) further comprises an infrastructure configuration system (402) that is designed and configured to:
a) access the generic device configuration database (322), the vendor configuration mapping database (422), and the service level rules database (425);
b) create specific infrastructure configuration data about the infrastructure (12); and
c) store the specific infrastructure configuration data in the specific device configuration database (424).

9. The system architecture of claim 8, wherein the device management system (400) further comprises:
a) a change audit database (324) that contains a record of changes made to the subscriber device (11) and of changes to the infrastructure (12); and
b) a configuration verification system (404) that verifies proper configuration of the subscriber device (11) and the infrastructure (12).

10. The system architecture of claim 6, wherein the generic device configuration (303) is a set top box (104).

11. The system architecture of claim 1, wherein the system control (14) further comprises an account management system (500), designed and configured to allow a subscriber to manage and review account and financial data about the services provided by the self-provisioning of services.

12. The system architecture of claim 11, wherein the account and financial data further comprises:
a) subscriber information;
b) authentication information;
c) billing account payment information; and
d) account history information.

13. The system architecture of claim 2, wherein the system control (14) further comprises a service management system (300) that allows the subscriber to choose from a group of functions designed to customize the services provided by the self-provisioning of services.

14. The system architecture of claim 13, wherein the service management system (300) further comprises a service configuration system (305) that coordinates the customizations elected by the subscriber.

15. The system architecture of claim 14, wherein the service configuration system (305) further comprises:
a) an authorization system (302) that authorizes the subscriber to self-provision services;
b) a capacity validation system (301) that determines whether the infrastructure (12) and the service provider (13) can support the self-provisioning of services;
c) a service request system (304) that provides notification regarding actions not automatically performed by the system control (14); and
d) a generic configuration system (303), that is designed to:
i) identify generic service provider provisioning parameters, infrastructure provisioning parameters and subscriber device provisioning parameters;
ii) provide the generic service provider provisioning parameters to the service provider (13); and
iii) store the generic infrastructure provisioning parameters and generic subscriber device provisioning parameters.

16. The system architecture of claim 15, wherein the generic configuration system (303) stores the generic infrastructure and subscriber device provisioning parameters in a generic device configuration database (322).

17. The system architecture of claim 16, wherein the generic device configuration (303) is used by the device management system (400).

18. The system architecture of claim 16, wherein the generic device configuration database (322) is used by a SDC system (401) and an infrastructure configuration system (402).

19. A method of self-provisioning services for a subscriber, the method comprising the steps of:
a) formatting services data provided by the subscriber via a user interface;
b) presenting the services data provided by the subscriber to the data via the user interface;
c) allowing the subscriber to change the services data via a service management function;
d) allowing the subscriber to conduct financial transactions relating to the self-provisioning of services and changes made by the subscriber to the services;
e) recording subscriber information in the form of changes to the services data and the financial transactions conducted within a database; and
f) translating the subscriber information into configuration commands, which are used to make changes to hardware and software systems relating the self-provisioning of services by a subscriber.

20. The method claim 19, wherein the user interface further formats an account configuration process that is designed to configure the database by adding users and checking service and payment histories.

21. The method of claim 20, wherein the account configuration process relays information within the database to a billing process that is designed to manage accounting and payment processing for the changes made to the services data by the subscriber.

22. The method of claim 20, wherein the account configuration process relays information within the database to an account database that contains information and service parameters pertaining to the subscriber.

23. The method of claim 20, wherein the account configuration process relays all information within the database to a change audit repository for creating a transactional history.
